(19) United States
(12) Patent Application Publication
(10) Pub. No.: US 2023/0127961 A1
(43) Pub. Date: Apr. 27, 2023

(54) SYSTEMS AND METHODS FOR END-TO-END TRANSACTIONS

(71) Applicant: GUBAGOO INC., Houston, TX (US)

(72) Inventors: Bradley Title, Delray Beach, FL (US); Ryan Osten, Toronto (CA); Dmytro Kabak, Boca Raton, FL (US)

(21) Appl. No.: 17/962,267

(22) Filed: Oct. 7, 2022

Related U.S. Application Data
(60) Provisional application No. 63/270,172, filed on Oct. 21, 2021.

(51) Int. Cl. G06Q 30/00; G06Q 40/02

(52) U.S. Cl. CPC G06Q 30/012; G06Q 40/025

(57) ABSTRACT

An apparatus for a transaction includes a memory and at least one processor coupled to the memory. The at least one processor is configured to generate a trade-in value with a payoff amount for a first item being traded in for a purchase of a second item. Additionally, the at least one processor is configured to get loan approval for a loan for the second item. The at least one processor is also configured to calculate payments for the loan for the second item. The at least one processor is also configured to present a contract for signing for a purchase of the second item. The at least one processor is also configured to accept a payment for the second item and send a communication to a consumer from a dealer of the second item.

### CROSS-REFERENCE TO RELATED APPLICATIONS

This application is a nonprovisional application which claims priority from U.S. provisional application No. 63/270,172, filed Oct. 21, 2021, which is incorporated by reference herein in its entirety.

### TECHNICAL FIELD

The disclosure relates generally to the field of end-to-end transactions.

### BACKGROUND

While certain solutions enable a consumer to do most of a vehicle purchase process online, none of these solutions currently incorporate all of the features necessary to complete an entire deal. For example, there are no solutions with a working instant lender approval, e-signature, e-contract, and payment capability. Most traditional vehicle purchase processes merely enable a customer to express interest in a vehicle and build the customer's deal but not consummate the deal. These traditional vehicle purchase processes do not complete end-to-end transactions.

Accordingly, it may be advantageous to provide online solutions that provide all of the features necessary to complete an entire deal, e.g., provides for an end-to-end transaction.

### SUMMARY

Disclosed are example embodiments of systems and methods for transactions. The method may include generating a trade-in value with a payoff amount for a first item being traded in for a purchase of a second item, getting loan approval for a loan for the second item, calculating payments for the loan for the second item, displaying dynamic and personalized service and warranty products for the second item, presenting a contract for signing for the purchase of the second item, accepting a payment for the second item, and sending a communication to a consumer from a dealer of the second item.

Disclosed are example embodiments of systems and methods for transactions. An apparatus for a transaction includes a memory and at least one processor coupled to the memory. The at least one processor is configured to generate a trade-in value with a payoff amount for a first item being traded in for a purchase of a second item. Additionally, the at least one processor is configured to get loan approval for the second item. The at least one processor is also configured to calculate payments for the loan for the second item. Additionally, the at least one processor is configured to display dynamic and personalized service and warranty products for the second item. The at least one processor is also configured to present a contract for signing for the purchase of the second item. The at least one processor is also configured to accept a payment for the second item and send a communication to a consumer from a dealer of the second item. The features and advantages described in the specification are not all-inclusive. In particular, many additional features and advantages will be apparent to one of ordinary skill in the art in view of the drawings, specification, and claims. Moreover, it should be noted that the language used in the specification has been principally selected for readability and instructional purposes and may not have been selected to delineate or circumscribe the disclosed subject matter.

A non-transitory computer-readable medium storing computer-executable code for transactions device. The code when executed by a processor causes the processor to generate a trade-in value with a payoff amount for a first item being traded in for a purchase of a second item, get loan approval for a loan for the second item, calculate payments for the loan for the second item, display dynamic and personalized service and warranty products for the second item, present a contract for signing for the purchase of the second item, accept a payment for the second item, and send a communication to a consumer from a dealer of the second item.

### BRIEF DESCRIPTION OF THE DRAWINGS

The foregoing summary, as well as the following detailed description, is better understood when read in conjunction with the accompanying drawings. The accompanying drawings, which are incorporated herein and form part of the specification, illustrate a plurality of embodiments and, together with the description, further serve to explain the principles involved and to enable a person skilled in the relevant art(s) to make and use the disclosed technologies.

FIG. 1 is a flowchart illustrating an example method 100 in accordance with the systems and methods described herein.

FIG. 2 is a diagram illustrating an example apparatus 200 that is in accordance with the systems and methods described herein.

The figures and the following description describe certain embodiments by way of illustration only. One skilled in the art will readily recognize from the following description that alternative embodiments of the structures and methods illustrated herein may be employed without departing from the principles described herein. Reference will now be made in detail to several embodiments, examples of which are illustrated in the accompanying figures. It is noted that wherever practicable similar or like reference numbers may be used in the figures to indicate similar or like functionality.

### DETAILED DESCRIPTION

The detailed description set forth below in connection with the appended drawings is intended as a description of configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well-known structures and components are shown in block diagram form in order to avoid obscuring such concepts.

Several aspects of systems consistent with the present disclosure will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends on the application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field-programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that a computer can access. By way of example, and not limitation, such computer-readable media can comprise random-access memory (RAM), a read-only memory (ROM), an electrically erasable programmable ROM (EEPROM), optical disk storage, magnetic disk storage, other magnetic storage devices, combinations of the types mentioned above of computer-readable media, or any other medium that can be used to store computer-executable code in the form of instructions or data structures that a computer can access.

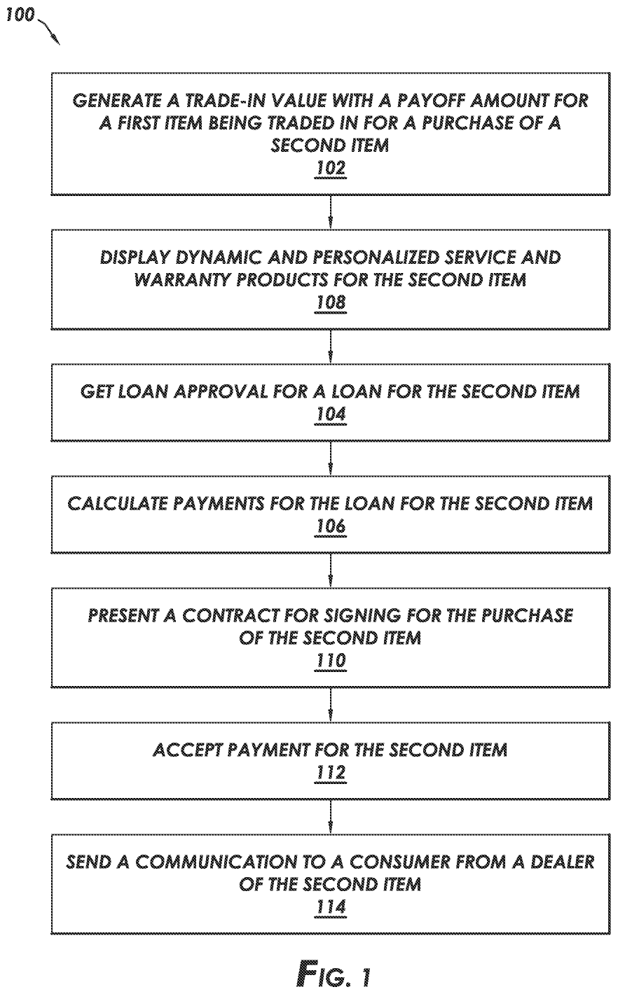

FIG. 1 is a flowchart illustrating an example method 100 in accordance with the systems and methods described herein. The method 100 may be a method for a transaction. The illustrated method of FIG. 1 includes generating a trade-in value with a payoff amount for a first item being traded in for a purchase of a second item (102), calculating payments for the loan for the second item (106), displaying dynamic and personalized service and warranty products for the second item (108), getting loan approval for a loan for the second item (104), presenting a contract for signing for the purchase of the second item (110), accepting a payment for the second item (112), and sending a communication to a consumer from a dealer of the second item (114).

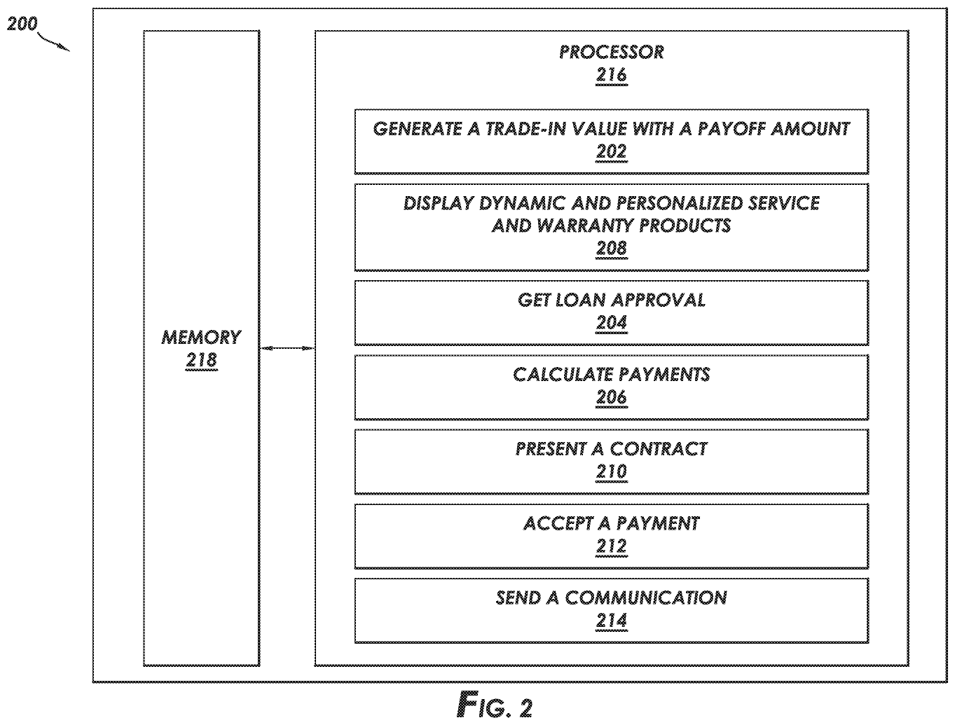

FIG. 2 is a diagram illustrating an example apparatus 200 that is in accordance with the systems and methods described herein. The example apparatus may be an apparatus for a transaction. The apparatus 200 may include a memory 218 and at least one processor 216. The at least one processor 216 may be coupled to the memory 218. Additionally, the at least one processor 216 may include blocks to implement the method 100 of FIG. 1. For example, the apparatus may include a generate a trade-in value with a payoff amount block 202, a get loan approval block 204, a calculate payments for the loan block 206, a display dynamic and personalized service and warranty products block 208, a present a contract block 210, an accept a payment block 212, and a send a communication block 214. These blocks may represent hardware, software, or some combination of hardware and software. The blocks may be functions executing within the processor 216. In other embodiments, one or more of the blocks may represent stand-alone hardware that may be coupled to the processor. Some examples may include a non-transitory computer-readable medium storing computer-executable code for transactions (e.g., memory 218).

In an example embodiment, a virtual retailing application may enable a user to buy a car. For example, the virtual retailing application may enable users to complete an entire vehicle purchase process online, e.g., an “end-to-end” transaction.

Some example embodiments may solve the problem of enabling full transactional capabilities through a confluence of several features, including a trade-in valuation tool with one or more of a Vehicle Identification Number (VIN) lookup, a license plate lookup, or another identification lookup, and a payoff lookup. In many locations, over 50% of customers may owe on their vehicle. Accordingly, in many locations, without a payoff lookup, an accurate trade estimate cannot be provided, precluding a transaction from consummating. One example embodiment may be able to map a VIN identified to multiple vehicle configurations to a specific vehicle using meta-analysis. (In some cases, a VIN alone may return multiple trims or multiple configurations.)

The example embodiment may also collect the consumer's license plate and state. This information may then be used to look up the consumer's vehicle in a Department of Motor Vehicle (DMV) database, a Department of Transportation (DoT) database, or another vehicle database, e.g., state or federal government database via, for example, a web-based application programming interface (API). Some example embodiments may use a non-governmental database or databases or a combination of government and non-government databases. In some embodiments, a database or databases may be accessed through an intermediate party such as Experian.

An example embodiment may schedule a test drive and/or delivery of vehicle to the consumer. For example, a processor may process the consumer's driver's license information and schedule a test drive and/or delivery of vehicle to the consumer. For example, the processor may verify that the driver's license is current and not suspended, or determine whether the driver's license is stolen or otherwise being used fraudulently. The address on the driver's license may be verified as current with the consumer, and consumer availability for a test drive, e.g., beginning at the showroom or beginning at another location such as the consumer's home, or home (or other location) delivery of the vehicle. In some example embodiments, a test drive may include a sales associate traveling to the consumer's home for a test drive. In some example embodiments delivery may not include a sales associate traveling to the consumer's home. In other embodiments, delivery may include a sales associate traveling to the consumer's home to answer any final questions the consumer may have or to otherwise interact with the consumer.

In one example embodiment, VIN, license plate, or other identifying information may be used as a condition precedent for finding the vehicle in a database. With vehicle year, make and model, the system would be unable to identify the specific vehicle and will not be able to get payoff amount.

In another embodiment, upon successfully finding vehicle information in a database or databases, e.g., governmental databases, non-governmental, or both governmental and non-governmental databases, the application may obtain one or more of the following basic vehicle information such as vehicle year, vehicle make, vehicle model, Vehicle Identification Number (VIN), vehicle color, or other vehicle information. This, along with mileage and vehicle condition, may be used to determine an estimated value of the vehicle by checking one of the possible Trade-In estimation vendors via the API. An example embodiment and application may support any trade-in price providers (e.g., Kelly Blue Book, Trade Pending, or other trade-in price providers). When trade-in information is returned, an application may normalize the output to a low-high range and apply configured modifiers that may affect the price presented to the consumer. In parallel, previously provided consumer's information (PII) along with the VIN may be leveraged to lookup a consumer or customers' credit data via a partner API (e.g., RouteOne, or other credit information provider). The credit information may be used to determine information about the lease/finance state of the vehicle. The returned data may be used to further modify the trade-in value of a consumer or consumers' vehicle by adjusting the value to reflect money owed.

In an example embodiment, the VIN or license plate may be used as a condition precedent for finding a vehicle in a database. An example embodiment that uses vehicle year, make, model, may not be able to identify a specific vehicle. In an example embodiment that is not able to identify a specific vehicle, the system may not be able to obtain a payoff amount.

A Finance and Insurance (F&I) menu may render products based on the customer's driving habits and the specific deal type (e.g., lease, finance, cash, or another deal type). In an example embodiment, a complex rule builder has been developed to facilitate the accurate display of Finance and Insurance products for the consumer based on the specific vehicle selected. The complex rule builder may enable a team with various options to match a dealership's products in a store. Matching the products a dealership sells in a store may including setting provider, description, videos, order, percentage-based markups, absolute dollar markup, deal type, other sales types, vehicle type, price, or other vehicle attributes.

The example embodiment may also use an in-Credit app that may submit consumer information to a network of lenders for consideration for a loan. The in-Credit app may return a near-instant decision to extend or not to extend credit to a consumer. In other examples, the in-Credit app may return a decision while the consumer waits a short period.

An embodiment may include “smart routing” to lenders. For example, when a customer selects a payment from a particular finance company, e.g., an offer for credit from a particular finance company where the offer may include a payment amount, such as an offer from Honda Finance (that includes an OEM rebate) or another finance company, the system may specify that the credit application go only to the particular finance company, e.g., Honda Finance.

The example embodiment may also have an E-signature feature. The E-signature feature may dynamically build and render the contract for the consumer. The E-signature feature may be particularly complex because each form may need to render according to a set of rules that may be configured, and all values may need to be populated within each form for the consumer.

The example embodiment may also facilitate maximum flexibility. Additionally, the example embodiment may account for differing rules. The example embodiment may include a document-building engine that enables the creation of individual documents. The creation of individual documents may be based on Portable Document Format (PDF) templates. The example embodiment may work via web interfaces. The web interfaces may allow users to configure tokens that may be placed on the document. During document generation inside an E-Sign platform (e.g., DocuSign), tokens may be replaced with captured data values or provide user input (e.g., a signature). The engine may be configured to generate document packets (e.g., deal jacket). The document packets may include any number of documents that may be dynamically applied based on geography (e.g., tax jurisdiction), nature of the financial deal (e.g., lease or finance), components of the transaction (e.g., presence of trade-in).

In an example embodiment, a payments feature may enable customers to pay. For example, a payment may be due at signing. The fee may be paid using Apple Pay, Google Pay, pay by credit card, debit card, a check, direct deposit, PayPal, or any other appropriate payment system or payment application.

An example embodiment may include robust video, text, and chat capabilities for the dealership and customer to communicate and adjust the deal throughout the process.

The advantages of combining all these features result in a complete online buying process that is not available in the market from any other vendor.

In the example embodiment, Virtual Retailing might start with a customer valuing the customer's trade-in vehicle (e.g., if the customer has a trade-in vehicle). For example, a customer may have the ability to input the license plate number and state of the customer's vehicle to identify the vehicle. After the vehicle is identified in the example embodiment, the customer may complete several inputs to provide more information about the vehicle. One problem with getting a trade evaluation may be identifying the customer's loan payoff on their current vehicle. In an example embodiment, a payoff API may look up a customer's payoff based on the customer's bank or lender information. For example, a customer may provide the bank or loan information and loan account number, or other loan information. Accordingly, accurate payments for vehicles may be obtained.

An embodiment may include a payment step. During the payment step, payment information may be displayed to the customer for finance of the vehicle being acquired or for lease for the vehicle being acquired. The embodiment may also be able to process a cash purchase. In the example embodiment, an accurate payment may be presented. An estimated payment may be presented in some embodiments, e.g., when an exact interest rate that a lender may extend is unknown. An itemized breakdown of taxes and fees may be included in the example embodiment and any standard manufacturer rebates. A customer may then select any conditional rebates for which they qualify.

An example embodiment may include a step for “Finance and Insurance” or F&I products. A problem with many tools in the market is that they do not personalize the products for the customer. An example embodiment may ask the customer for driving habits to personalize the term of the products (e.g., 100,000 miles coverage vs. 50,000 miles coverage). Additionally, the embodiment may display only those products applicable to finance, lease, or cash accordingly based on the deal type and the actual vehicle. In an example embodiment, videos may be added to any product. A configuration panel may enable the setup of F&I products. The configuration panel may allow the addition of various attributes such as description, videos, e.g., reference the video Uniform Resource Locator (URL), pricing configuration, and eligibility (e.g., deal type). In an example, once a consumer reaches the F&I step in the vehicle acquisition process, an example system may process the information captured to this point and apply the data to render eligible F&I products.

In an example embodiment, the customer may complete a full credit application to apply for financing of the deal. A problem with many tools in the market is that, while the tool may allow a customer to submit a credit application, the tool does not give the customer instant feedback about whether a lender approves the customer. In the legacy case, the customer must wait to get a loan approval by email or phone and, therefore, cannot complete the entire purchase process. In an example embodiment, an instant lender approval may be returned to the customer to accept the approval and continue with the customer's purchase.

In an example embodiment, after selecting the customer's loan offer, the customer may be prompted to upload additional documents necessary for a deal, including an image of a driver's license or insurance card.

In an example embodiment, a signature step may be provided. The signature step may be unique to the Virtual Retailing application. An example embodiment may be integrated with DocuSign or other e-signature applications. The e-signature application may enable example systems to present a complete “deal jacket” to customers with all documents necessary to contract their deal. The forms generated for the customer may match a particular deal exactly including, for example, dynamic form rendering (e.g., rendering the correct forms based on lease or finance, trade, co-signer, and other aspects of the deal) may be performed. Token insertion (e.g., inserting the values of the deal into the forms) may also be performed. In an example embodiment, a configuration tool may be used to enable form generation. In addition, some embodiments of the systems and methods described herein may include integrations with F&I product providers to gather the provider's forms in real-time and send the signed forms to the providers directly.

In an example embodiment, e.g., after signature, the customer may select how the customer would like the vehicle delivered (e.g., at home or in-store). When the customer selects home delivery, the systems and methods described herein may enable the store to configure the fees that the store would like to implement (for example, a store may configure free delivery within 50 miles and 0.25 cents after that).

In an example embodiment, the customer may check out by paying an amount due at signing using Apple Pay, Google Pay, credit card, debit card, a check, direct deposit, or PayPal, or any other appropriate payment system or payment application.

In some embodiments, at any time, the dealership may use our dealer-facing app to see all customer deals in real-time, chat, text, or email the customer with updated deals or start a video conference with the customer while on the site.

Some embodiments may allow a shop by payment feature. For example, a possible purchaser may be able to filter vehicles by the vehicle payment or vehicle payment range, e.g., $300 to $400, $500 to $650, or other payment amounts. The payment amount for a vehicle may be based on calculations using one or more of the following: the vehicle price, any interest rate or rates offered to the purchaser by a bank or other lending institution, an estimated interest rate, e.g., by a car dealership, an amount of money down, a credit score for the purchaser or other credit information, a requested term for the loan, a proposed term of the loan, e.g., from the lender or dealership, or other factors related to the payment of any proposed loan, other vehicle costs, e.g., taxes, fees, loan fees, or other costs, or any other items that may impact loan payments for the loan.

Accordingly, in an example embodiment, one of the Virtual Retailing (VR) components may be a mechanism enabling consumers to query available dealership vehicles by a dynamic set of parameters, one of which may be the desired monthly price. To provide an estimate or “penny-accurate pricing,” the systems and methods described herein may include a mechanism capable of quickly identifying the matching vehicles without involving time-consuming APIs necessary to calculate the monthly payment based on consumer-defined criteria. An algorithm capable of deriving monthly payments based on previously calculated data has been developed to address the need. The algorithm may bypass any APIs. To facilitate the bypassing of any APIs, the application may determine a baseline rate using internal or external APIs (e.g., PaymentDriver) that establishes a base rate and calculates a dynamic modifier that may be used to perform subsequent calculations (e.g., a change in monthly price based on a change in down payment amount) without involving the API. When a consumer indicates the consumer's desired monthly fee, an example application may use the modifier to adjust the baseline monthly fee to reflect the user requested value and allow application of the search filter.

Some example embodiments may perform vehicle data normalization. For example, as part of providing a comprehensive vehicle information packet to the consumer, information from multiple disparate data sources such as APIs, Data Feeds, etc., may be consolidated with non-uniform data structure and composition. To address the need to consolidate data, a heuristic mechanism for extracting, consolidating, and refining data has been developed to present the data to a consumer concisely. To identify vehicle features and capabilities, VIN decoding may be used. VIN decoding may translate a vehicle's VIN to a list of identifiable attributes; however, in some cases, a VIN may translate to multiple vehicles with different trims. In the cases where a VIN translates to multiple vehicles with different trims, additional processing may be needed to identify the specific trim for the vehicle in question. First, an application may try to match the trim provided inside the inventory feed to one of the returned values. In an example embodiment, direct string matching or proximity matching may be performed using various algorithms. However, the direct string-matching approach or proximity matching does not always produce an outcome due to a high degree of similarity between trims. In the cases where the direct string-matching approach or proximity matching does not produce an outcome, an example application may perform a price analysis to match the Manufacturer's Suggested Retail Price (MSRP) of the vehicle inside the inventory feed (e.g., provided by the Dealer) to the MSRP returned by VIN decode to identify the closest match. Heuristics may also be used. The heuristics may include translating colors to visualizable elements (e.g., a preview of the vehicle in the desired color).

In most cases, automotive color names are unique to each manufacturer (e.g., “Winning Turquoise Pearl”) and cannot be directly translated to red, green, blue (RGB) values or Cyan-Magenta-Yellow-Key (CMYK) values (e.g., 4-color ink model used for printing) that can be rendered on the web. For those cases, a color decoding service leveraging a combination of external APIs and text matching heuristics to map the underlying value to the corresponding RGB value may be used. The heuristics may be based on text proximity values retrieved from external sources and the source color. The highest score value may be picked as the most likely probability.

An embodiment may include a mechanism to identify an eligible vehicle. For Virtual Retailing, not all vehicles can be sold online based on the availability of financial means to facilitate the transaction or non-validity of source vehicle data. A mechanism for pre-processing vehicle data has been developed. The mechanism may ensure eligibility and identify baseline parameters of the available promotional deals available. Identifying baseline parameters may be accomplished via a pre-processor that may examine all vehicles as they are received from an inventory feed (e.g., provided by the Dealer) and determines the eligibility of the vehicles for Virtual Retailing, based vehicle attributes (e.g., mileage, age) and availability of financing and/or leasing options obtained via API (DealerTrack). For eligible vehicles, applicable promotions and pricing options (e.g., lease/finance monthly rates) may be stored in a database (e.g., Redis) and leveraged to render interactive components that allow consumers to initiate Virtual Retailing flow.

To facilitate consumer engagement with vehicle acquisition flow, a mechanism capable of dynamically analyzing the dealer site and dynamically introduce interactive elements (such as CTAs) for an eligible vehicle enables the consumer to initiate Virtual Retailing (VR) based on desired step (e.g., price, trade-in, or other vehicle attribute). In an example embodiment, a mechanism for automatically inserting interactive call-to-action (CTA) elements may be used. This mechanism accounts for different vendors involved in building dealer sites, identifies vehicle User Interface (UI) elements on the page, qualifies vehicles (leverages eligibility data referenced above), and based on these parameters with additional configurable controls, some example embodiments introduce interactive buttons. The application contains a framework for processing vehicle search pages (VSP) show information about multiple vehicles and vehicle display pages (VDP) that show details of a particular vehicle. The framework allows for identifying specific sections relating to a given vehicle, extracting the VIN of said vehicle, and meaningfully appending interactive elements that would allow consumers to initiate a Virtual Retailing process for said vehicle. Given the differences between different website vendors used by dealers, a set of vendor-specific drivers was devised to extract this information accurately with minimal processing overhead using JavaScript and allow the insertion of configured content (e.g., call to action elements). Configuration within the application allows users to select a supported driver for a website provider and configure the visual appearance (e.g., color, size, presence of lender logos) of the call-to-action (CTA) and the Virtual Retailing flow to be initiated.

This technology may be applied to other industries with complex sales and high-value items such as real estate, boating, or other industries.

An aspect may send configured deals to a customer via a real-time communication. For example, an aspect may send configured deals to a customer via a real-time video communication. Real-time communication may be audio and/or video that is transmitted immediately after (or with only a slight delay) the audio and/or video has been captured by a microphone and/or a camera.

An aspect may include calculating delivery fees and scheduling deliveries. An aspect may include dynamically analyzing a website. Another aspect may include introducing a CTA. An aspect may include a Heuristic for mapping color names to renderable color codes and images. An aspect may include a mechanism for reliably identifying specific vehicle types based on VIN, wherein the VIN maps to multiple vehicles. The various aspects and embodiments may be combined.

One or more of the components, steps, features, and/or functions illustrated in the figures may be rearranged and/or combined into a single component, block, feature, or function or embodied in several components, steps, or functions. Additional elements, components, steps, and/or functions may also be added without departing from the disclosure. The apparatus, devices, and/or components illustrated in the Figures may be configured to perform one or more of the methods, features, or steps described in the Figures. The algorithms described herein may also be efficiently implemented in software and/or embedded in hardware.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

Some portions of the detailed description are presented in terms of algorithms and symbolic representations of operations on data bits within a computer memory. These algorithmic descriptions and representations are the methods used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, or otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following disclosure, it is appreciated that throughout the disclosure terms such as “processing,” “computing,” “calculating,” “determining,” “displaying,” or the like, refer to the action and processes of a computer system, or similar electronic computing device, that manipulates and transforms data represented as physical (electronic) quantities within the computer system's registers and memories into other data similarly represented as physical quantities within the computer system's memories or registers or other such information storage, transmission or display.

Finally, the algorithms and displays presented herein are not inherently related to any particular computer or other apparatus. Various general-purpose systems may be used with programs in accordance with the teachings herein, or it may prove convenient to construct a more specialized apparatus to perform the required method steps. The required structure for a variety of these systems will appear from the description below. It will be appreciated that a variety of programming languages may be used to implement the teachings of the invention as described herein.

The figures and the following description describe certain embodiments by way of illustration only. One skilled in the art will readily recognize from the following description that alternative embodiments of the structures and methods illustrated herein may be employed without departing from the principles described herein. Reference will now be made in detail to several embodiments, examples of which are illustrated in the accompanying figures. It is noted that wherever practicable similar or like reference numbers may be used in the figures to indicate similar or like functionality.

The foregoing description of the embodiments of the present invention has been presented for the purposes of illustration and description. It is not intended to be exhaustive or to limit the present invention to the precise form disclosed. Many modifications and variations are possible in light of the above teaching. It is intended that the scope of the present invention be limited not by this detailed description but rather by the claims of this application. As will be understood by those familiar with the art, the present invention may be embodied in other specific forms without departing from the spirit or essential characteristics thereof. Likewise, the particular naming and division of the modules, routines, features, attributes, methodologies, and other aspects are not mandatory or significant, and the mechanisms that implement the present invention or its features may have different names, divisions, and/or formats.

Furthermore, as will be apparent to one of ordinary skill in the relevant art, the modules, routines, features, attributes, methodologies, and other aspects of the present invention can be implemented as software, hardware, firmware, or any combination of the three. Also, wherever a component, an example of which is a module, of the present invention is implemented as software, the component can be implemented as a stand-alone program, as part of a larger program, as a plurality of separate programs, as a statically or dynamically linked library, as a kernel loadable module, as a device driver, and/or in every and any other way known now or in the future to those of ordinary skill in the art of computer programming.

Additionally, the present invention is in no way limited to implementation in any specific programming language, or for any specific operating system or environment. Accordingly, the disclosure of the present invention is intended to be illustrative, but not limiting, of the scope of the present invention, which is set forth in the following claims.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims.

Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

1. A method comprising:
generating a trade-in value with a payoff amount for a first item being traded in for a purchase of a second item;
getting loan approval for a loan for the second item;
calculating payments for the loan for the second item;
displaying dynamic and personalized service and warranty products for the second item;
presenting a contract for signing for the purchase of the second item;
accepting a payment for the second item; and
sending a communication to a consumer from a dealer of the second item.

2. The method of claim 1, wherein the first item is a vehicle.

3. The method of claim 1, wherein the second item is a vehicle.

4. The method of claim 1, further comprising sending configured deals to a customer via a realtime communication.

5. The method of claim 1, further comprising:
calculating delivery fees; and
scheduling deliveries.

6. The method of claim 1, further comprising:
dynamically analyzing a website;
introducing a call-to-action (CTA);
mapping color names to renderable color codes and images; and
identifying specific vehicle types based on vehicle identification number (VIN), wherein the VIN maps to multiple vehicles.

7. An apparatus for a transaction, comprising:
a memory; and
at least one processor coupled to the memory and configured to:
generate a trade-in value with a payoff amount for a first item being traded in for a purchase of a second item;
get loan approval for a loan for the second item;
calculate payments for the loan for the second item;
display dynamic and personalized service and warranty products for the second item;
present a contract for signing for the purchase of the second item;
accept a payment for the second item; and
send a communication to a consumer from a dealer of the second item.

8. The apparatus of claim 7, wherein the first item is a vehicle.

9. The apparatus of claim 7, wherein the second item is a vehicle.

10. A non-transitory computer-readable medium storing computer-executable code for transactions, the computer-executable code, when executed by a processor, cause the processor to:
generate a trade-in value with a payoff amount for a first item being traded in for a purchase of a second item;
get loan approval for a loan for the second item;
calculate payments for the loan for the second item;
display dynamic and personalized service and warranty products for the second item;
present a contract for signing for the purchase of the second item;
accept a payment for the second item; and
send a communication to a consumer from a dealer of the second item.
